(19) United States
(12) Patent Application Publication
(10) Pub. No.: US 2012/0321404 A1
(43) Pub. Date: Dec. 20, 2012

(54) Method for Gear Pre-Cutting of a Plurality of Different Bevel Gears and Use of an According Milling Tool

(76) Inventor: Karl-Martin Ribbeck, Remscheld (DE)

(21) Appl. No.: 13/495,290

(22) Filed: Jun. 13, 2012

(30) Foreign Application Priority Data
Jun. 16, 2011 (EP) EP 11 170 148.8

(51) Int. Cl. B23F 5/24

(52) U.S. Cl. 409/13

(57) ABSTRACT

Soft milling bevel gear teeth on multiple similar bevel gears using a universal hobbing tool with a set of bar cutters comprising a plurality of pairs of inner and outer cutting edges, having four machining phases: 1) simultaneous milling machining a first bevel gear's convex inner and concave outer flanks with the pairs; 2) milling finishing pre-machining either the concave outer flanks with the outer cutting edges the convex inner flanks with the inner cutting edges without employing respective other cutting edges; 3) using the same tool with the same set of cutter bars to pre-tooth a second similar bevel gear, including simultaneous milling machining the gear's convex inner and concave outer flanks; 4) milling finishing pre-machining on the second gear either the concave outer flanks with the outer cutting edges or the convex inner flanks with the inner cutting edges without employing respective other cutting edges.

### CROSS REFERENCE TO PRIORITY AND RELATED APPLICATIONS

This application claims priority under 35 U.S.C. §119(a)-(d) to European Patent Application No. EP 111 70 148.8, filed Jun. 16, 2011, which is hereby incorporated by reference in its entirety as part of the present disclosure as if fully set forth herein.

### FIELD OF THE INVENTION

The subject of the invention is a method for gear pre-cutting of a plurality of different bevel gears. Also, the use of an according milling tool is concerned.

### BACKGROUND INFORMATION

There are numerous methods for machining gear wheels. In the chip-producing manufacturing of helical bevel gears, a distinction is made between the single indexing method and the continuous method, which is partly also called the continuous indexing method.

In the continuous method (also called continuous hobbing, continuous indexing process or face hobbing) for example a cutter head tool comprising inner cutters (IM) and outer cutters (AM) arranged in groups are employed in order to cut the convex and the concave flanks of the teeth of a workpiece. In the continuous method, the workpiece is cut ready in one clamping in an uninterrupted method. The continuous method is based on very complex, coupled sequences of movements, in which the tool and the workpiece to be machined perform a continuous indexing movement relative to each other. The indexing movement results from the coordinated driving of plural axes drives of an according machine. In the continuous indexing method, the rotation of the cutter head and of the workpiece to be machined are coupled such that only one group of cutters moves through a tooth gap and the next group of cutters moves through the next gap. The indexing thus occurs continuously and all gaps are generated quasi-simultaneously. As a result of this coupled movement, an extended epicycloid results as a longitudinal flank line on the plane gear of the bevel gear to be generated.

In the indexing method (also called single indexing method or face milling) one tooth gap is machined, then a relative displacement movement of driving the tool out of a tooth gap and a so-called indexing movement (indexing rotation) occurs, in which the workpiece rotates relative to the tool, before then the next tooth gap is machined. Thus, a toothed wheel is manufactured step by step and gap by gap. In the single indexing method, a first cutter head having inner cutting edges and outer cutting edges may be used in order to cut inner flanks (convex tooth flanks) on the workpiece and to preparatorily machine outer flanks. The outer cutting edges do not generate the final geometry of the outer flanks. Then, the first cutter head may be exchanged by a second cutter head, which is equipped with outer cutting edges, in order to finish cut the outer flanks (concave tooth flanks) on the workpiece. This procedure is also called single-sided cutting. The cutting edges of the tools are arranged circularly (e.g., for a front cutter head) and the flank lines, which are generated on the workpiece, thus have the shape of a circular arc.

In the described single indexing method, an exchange of the cutter head occurs, which leads to a prolongation of the total machining time and which also may involve inaccuracies, because each clamping or new clamping may lead to small deviations from the ideal position. It is an advantage of the single-sided single indexing method involving two separate cutter heads, that both flanks can be optimized quasi independently from one another.

The so-called completing method is a particular single indexing method that is employed preferably in large-scale series manufacturing. In FIG. 1A, a representation is shown of a tool 1 having an inner cutter 3 and an outer cutter 4, which is employed for completing with a two-flank cut. The tool 1 is employed for gear pre-cutting. In the gear pre-cutting, the outer cutter 4 cuts the outer flanks (concave tooth flanks) on the workpiece 2 and the inner cutter 3 cuts the inner flanks (convex tooth flanks) on the workpiece 2. The tool tip width of the inner and outer cutters 3, 4 is referenced with the numeral s_{a0, soft} here. This tool tip width is smaller than the tip distance w_{soft} of the two cutters 3, 4 together, as shown in FIG. 1A.

In FIG. 1B, the tooth gap 5* is shown after the gear pre-cutting. The effective gap width e_{fn, soft} of the pre-toothed tooth gap 5* is as great as the tip width w_{soft} of both cutters 3, 4.

Now, after the gear pre-cutting and the hardening, a full cutting tool 6 (a grinding disk in most cases) comprising an according profile is applied, in order to finish machine the tooth gap 5*. The according step is shown in FIG. 1C. The tip width of the full cutting tool 6 is referenced with the reference numeral w_{hard} here. The final tooth gap 5 can be seen in FIG. 1D. It has a final gap width e_{fn, hard}, which is as great as the tip width w_{hard} of the full cutting tool 6.

In the completing, a homogeneous flank dimension of the pre-cut tooth gap 5* in the normal direction is achieved in most cases by a variation of the tool tip radii for otherwise equal machine settings. Thereby, the tip radius of the inner cutter 3 becomes greater by the flank dimension with respect to the tip radius of the full cutting tool 6 or the grinding disk for the hard machining, while the tip radius of the outer cutter 4 becomes smaller by the same dimension.

In the completing method, a ring gear or a pinion is finish machined completely involving a two-flank cutting. Compared to other single indexing methods, the completing method is characterized by a higher productivity (doubled metal-cutting power). A change of the flank shape is more difficult however, because changes of the kinematics of the machine always have an influence on both flanks, as is the case for all methods involving a two-flank cutting. It is thus a disadvantage of the completing method involving the two-flank cutting that consequent to a change of one flank by means of the machine kinematics, also a change of the other flank results. Thus, changes are possible only if they are “compliant with two-flank cutting.”

Now, there are often situations in which a plurality of similar bevel gears has to be manufactured. For example, in the automotive industry, the bevel gears of the different gear transmission types often differ only in small differences in the geometry, such as normal module, pressure angle and transmission ratios. Up to now, a plurality of milling tools and a plurality of sets of bar cutters are needed in order to be able to manufacture the one type of a bevel gear or another type as needed. In each case, the cutter bars must be taken out of the cutter head and other cutter bars must be inserted precisely in respect of the position, or the whole cutter head is exchanged for another one equipped differently. The effort is great and capital is bound, because in each case a plurality of different sets of cutter bars or completely equipped cutter heads must be stored and provided.

### SUMMARY OF THE INVENTION

It is an object of the present invention to develop a method, which helps to reduce the tool cost and the effort in such situations.

Accordingly this method is solved by a method that is based on the principle of the semi-completing method. A semi-completing method is performed with a universal tool that is equipped with pairwisely arranged inner and outer cutters in order to finish pre-cut different similar bevel gears.

The invention assists in manufacturing, respectively, the gear pre-cutting, of different similar bevel gears using one and the same universal milling tool. Using this universal milling tool, different bevel gears of a group of bevel gears can be manufactured, as long as these bevel gears are similar. Herein, bevel gears are considered as similar bevel gears, if their average normal module deviates only slightly, if their pressure angles differ only slightly, and if their transmission ratios are comparable, so that similar curvature conditions result at the teeth.

In the gear pre-cutting, the convex and concave flanks of the bevel gear are milled using separate machine settings.

In one aspect,
either pairwisely arranged inner cutters and outer cutters are employed, wherein each inner cutter has a cutting edge that is called inner cutting edge, and each outer cutter has a cutting edge that is called outer cutting edge,
or a full cutter comprising inner cutting edges and outer cutting edges is employed.

It is an advantage of the invention that the universal milling tool does not have to be exchanged in the gear pre-cutting of similar bevel gears.

The method according to the invention can be performed both as a dry or a wet machining.

Further details and advantages of the invention are described in the following on the basis of embodiment examples and with reference to the drawings.

### BRIEF DESCRIPTION OF THE DRAWINGS

FIG. 1A shows a schematic cross-sectional representation of a known completing method during the gear pre-cutting;

FIG. 1B shows a schematic cross-sectional representation of a tooth gap after the gear pre-cutting of FIG. 1A;

FIG. 1C shows a schematic cross-sectional representation of a known method for hard machining, which is performed after the gear pre-cutting and hardening;

FIG. 1D shows a schematic cross-sectional representation of the tooth gap after the hard machining of FIG. 1C;

FIG. 2A shows a schematic cross-sectional representation of a first machining phase during the finish gear pre-cutting of the outer flank using an outer cutting edge of an outer cutter and the simultaneous gear pre-cutting of the inner flank using an inner cutting edge of an inner cutter;

FIG. 2B shows a schematic top view of a bevel gear during the first machining phase shown in FIG. 2A;

FIG. 2C shows a schematic cross-sectional representation of a second machining phase during the finish gear pre-cutting of the inner flank using the inner cutting edge of the inner cutter;

FIG. 2D shows a schematic top view of the bevel gear during the second machining phase shown in FIG. 2C;

FIG. 2E shows a schematic cross-sectional representation of a tooth gap after the finish gear pre-cutting according to FIGS. 2A to 2D;

FIG. 2F shows a schematic cross-sectional representation of a known method for hard machining, which is performed after the finish gear pre-cutting and hardening;

FIG. 2G shows a schematic cross-sectional representation of a tooth gap after the hard machining according to FIG. 2F;

FIG. 3A shows a schematic cross-sectional representation of a first machining phase during the finish gear pre-cutting of the outer flank of a further bevel gear using an outer cutting edge of an outer cutter and the simultaneous gear pre-cutting of the inner flank using the inner cutting edge of an inner cutter, wherein the same universal tool as in FIG. 2A is applied;

FIG. 3B shows a schematic cross-sectional representation of a second machining phase during the finish gear pre-cutting of the inner flank of the further bevel gear of FIG. 3A using the inner cutting edge of the inner cutter;

FIG. 4A shows a schematic cross-sectional representation of a first machining phase during the finish gear pre-cutting of the outer flank using an outer cutting edge of a full cutter and the simultaneous gear pre-cutting of the inner flank using the inner cutting edge of the full cutter;

FIG. 4B shows a schematic cross-sectional representation of a second machining phase during the finish gear pre-cutting of the inner flank using the inner cutting edge of the full cutter;

FIG. 4C shows a schematic cross-sectional representation of a tooth gap after the finish gear pre-cutting according to FIGS. 4A to 4B;

FIG. 4D shows a schematic cross-sectional representation of a known method for hard machining, which is performed after the finish gear pre-cutting and hardening;

FIG. 4E shows a schematic cross-sectional representation of a tooth gap after the hard machining according to FIG. 4D; and

FIG. 5 shows a perspective view of an exemplifying universal hobbing tool, which is equipped with a set of bar cutters comprising a plurality of pairs of inner cutters and outer cutters.

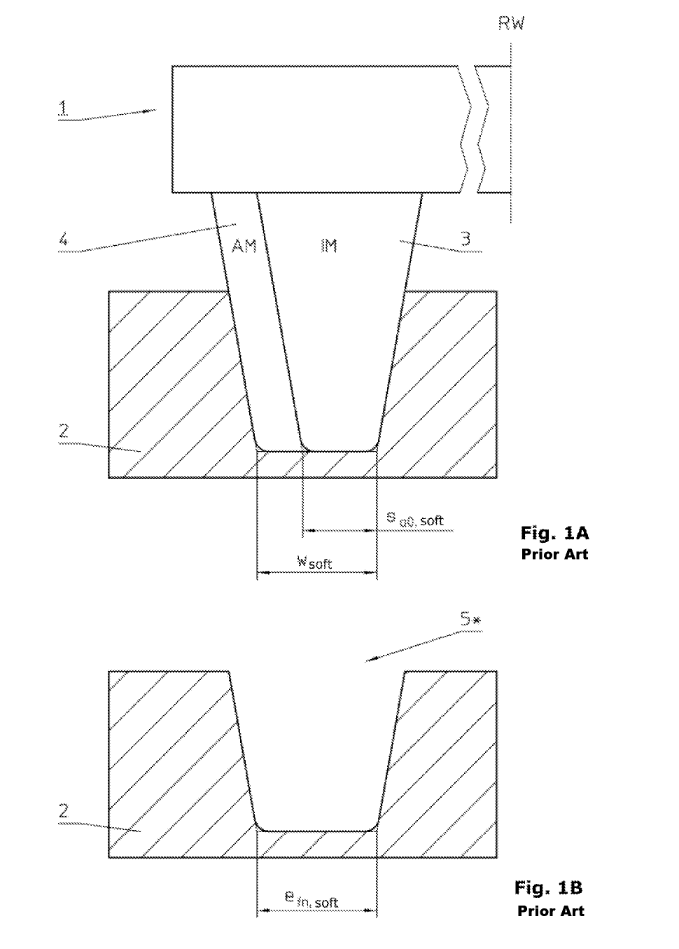

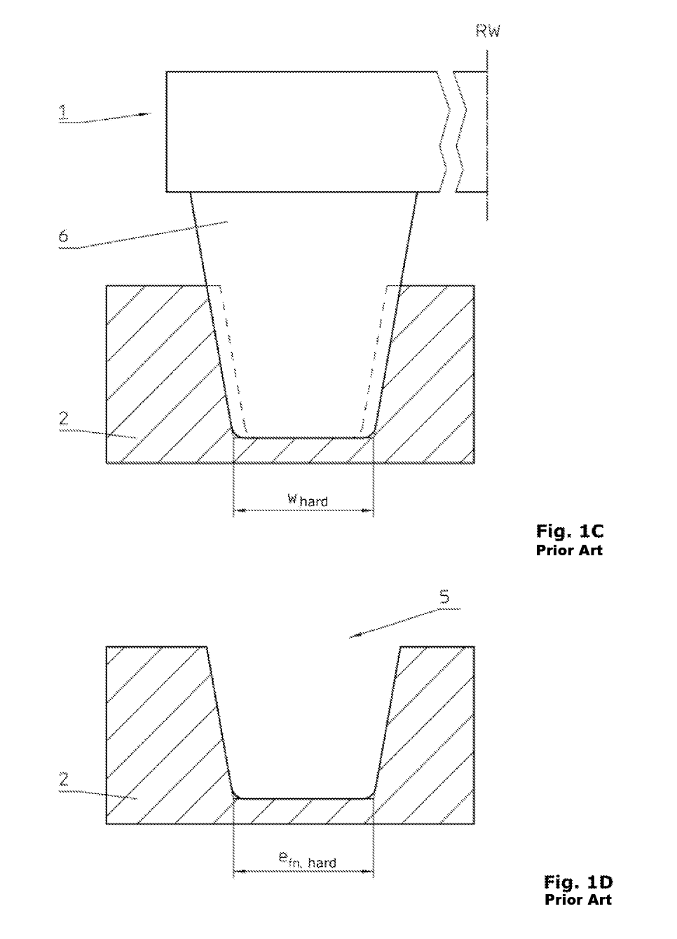

### DETAILED DESCRIPTION OF EMBODIMENTS OF THE INVENTION

In relation with the present description, terms are utilized which are also used in relevant publications and patents. It is noted, however, that the use of these terms shall merely serve a better understanding. The inventive idea and the scope of the patent claims shall not be limited in their interpretation by their specific choice of the terms. The invention can be transferred without further ado to other systems of terminology and/or technical areas. In other technical areas, the terms have to be applied according to their sense.

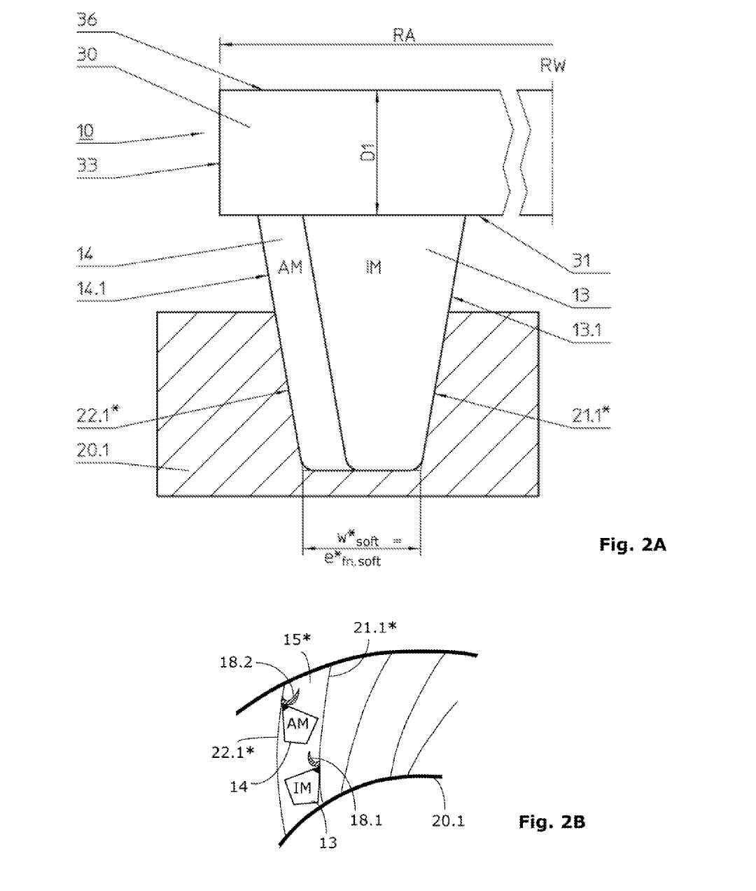

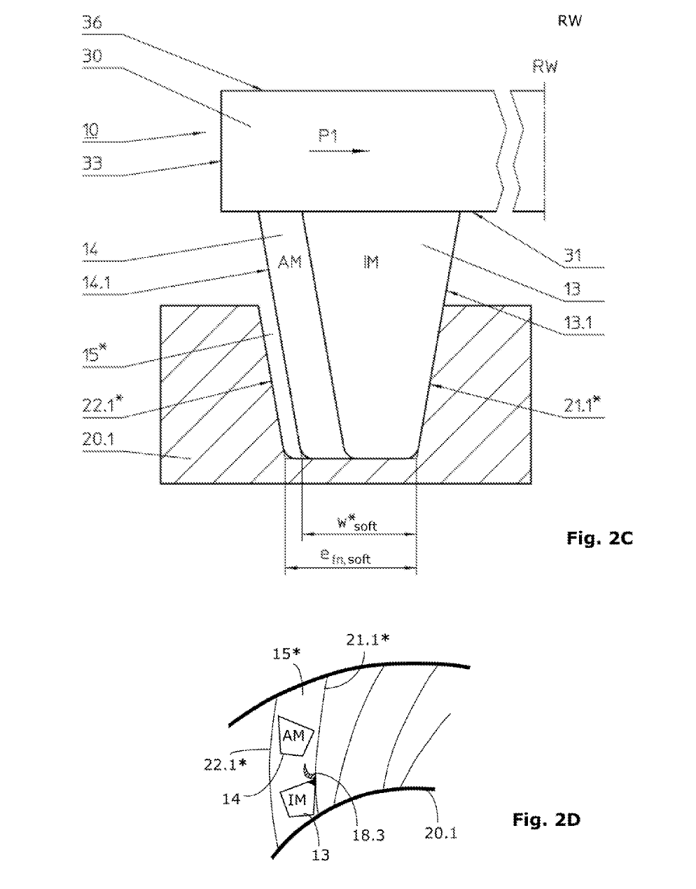

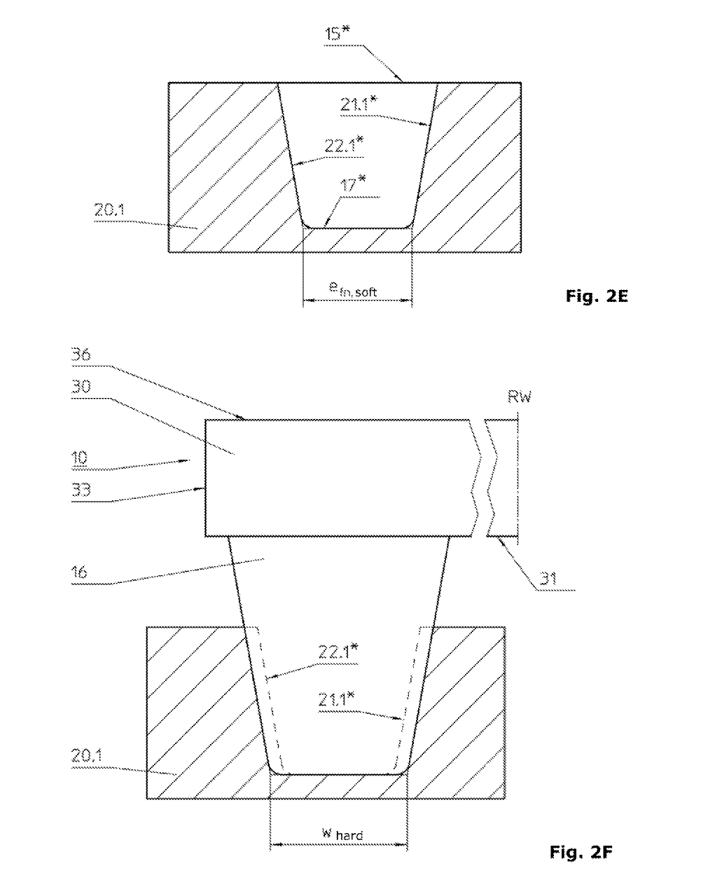

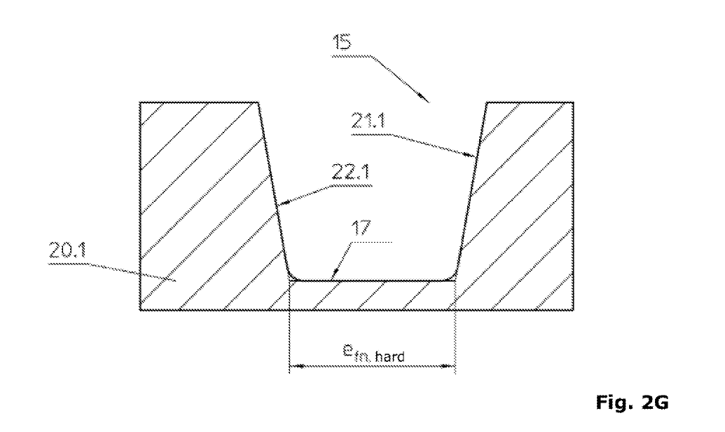

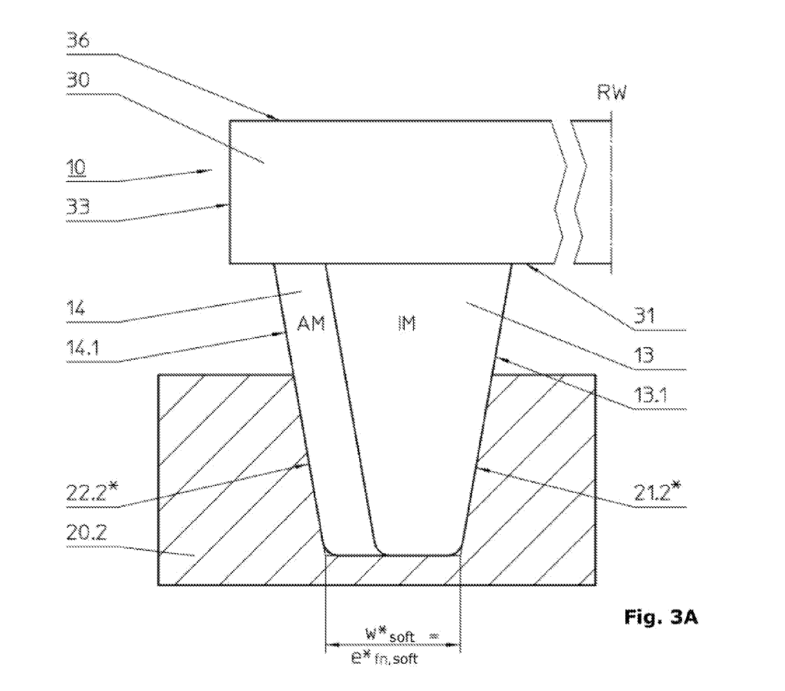

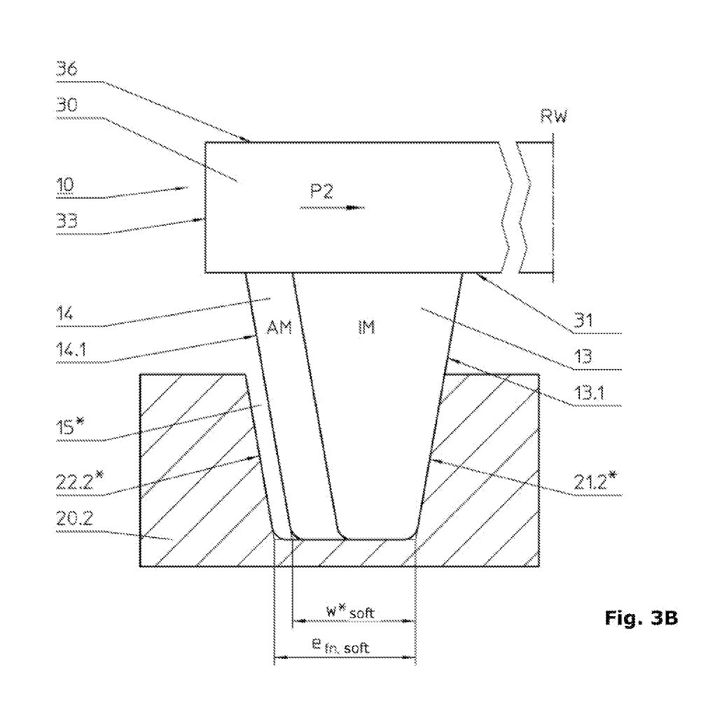

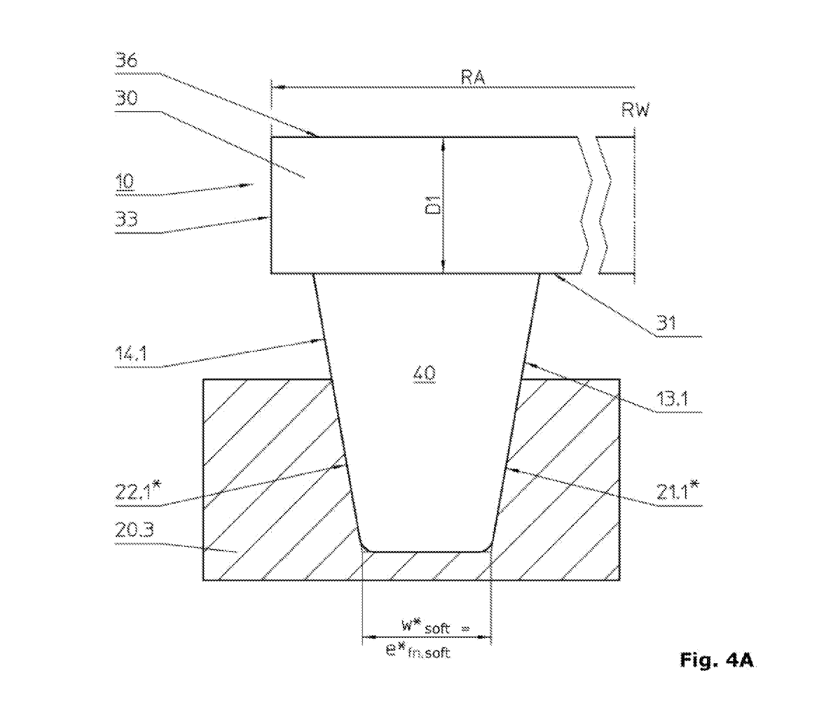

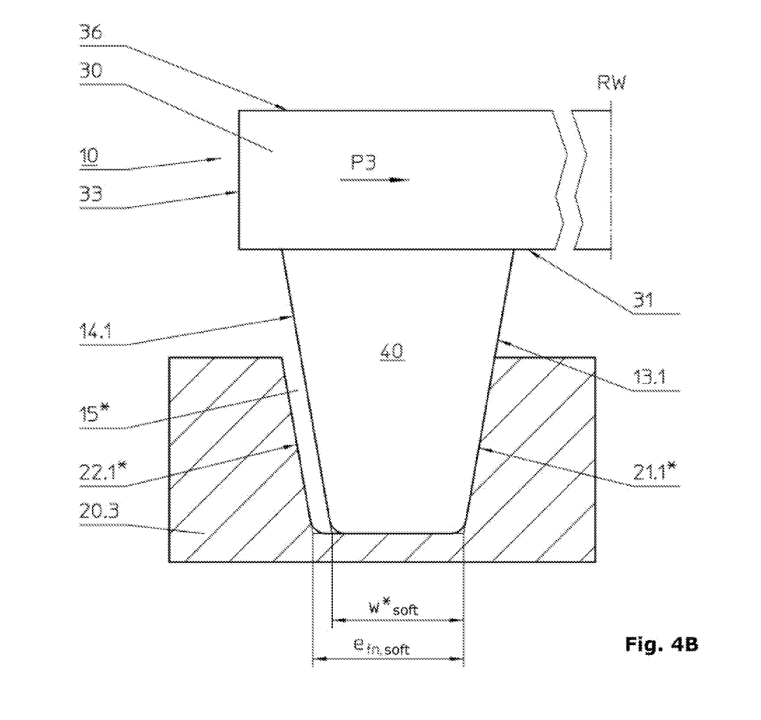

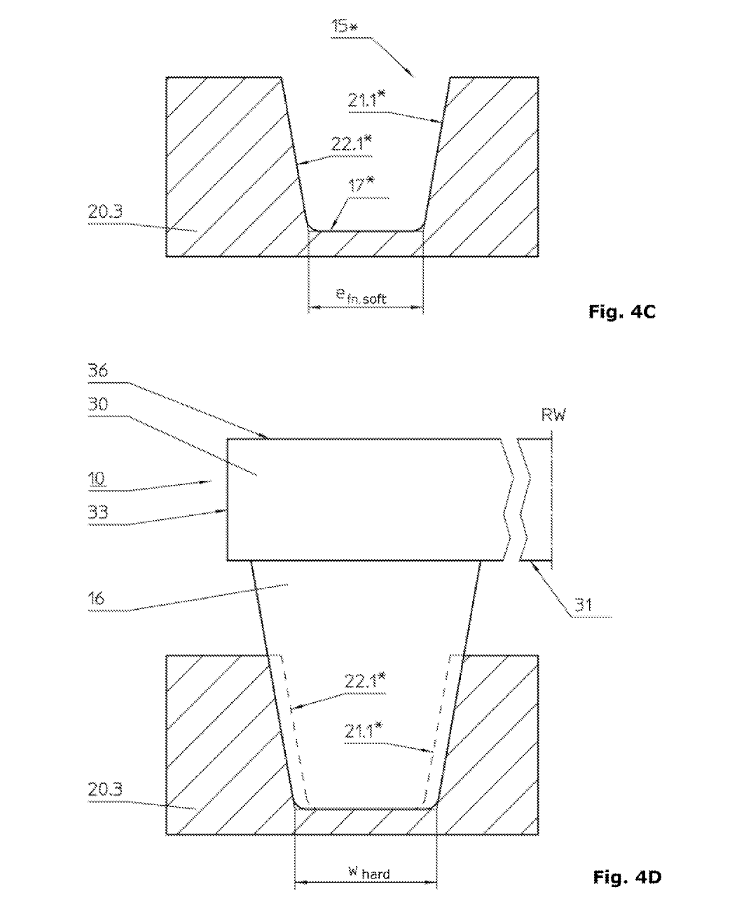

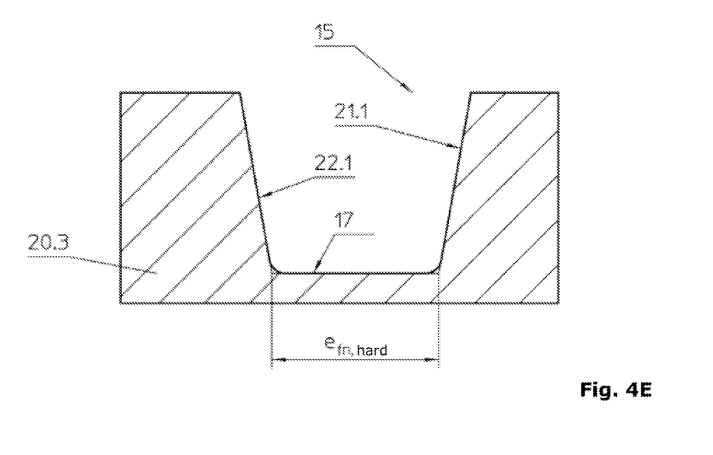

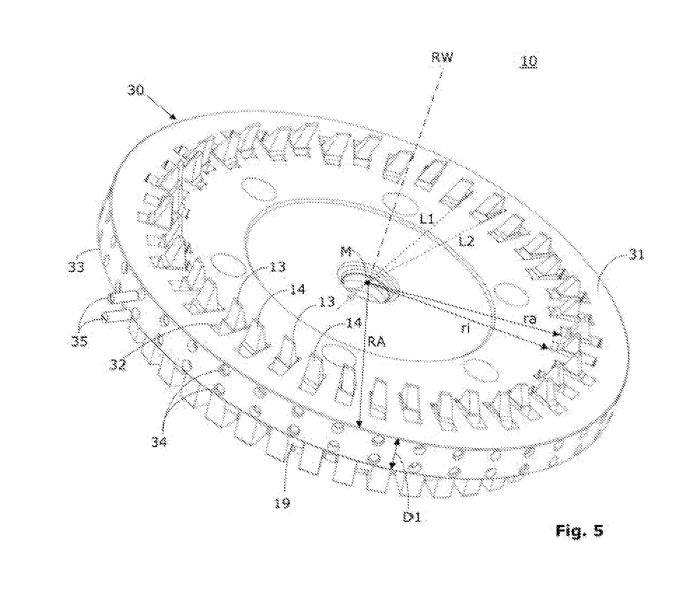

The FIGS. 2A to 3B are schematic and not to scale. In the FIGS. 2A, 2C, 2F, 3A, 3B, for reasons of simplicity, only the base body 30 of the universal milling tool 10 is shown as a cross-section through a circular disk. The front surface 31 directed towards the workpiece, on which the inner cutters 13 and outer cutters 14 of the FIGS. 2A to 3B, respectively the full cutters of the FIGS. 4A to 4D, are arranged, correspond to the upper side of the circular disk that is visible in FIG. 5. The front surface 36 directed away from the workpiece is shown as a smooth (not structured) surface in the FIGS. 2A, 2C, 2F, 3A, 3B, 4A, 4B, 4D. In FIG. 5, this front surface 36 directed away from the workpiece is structured, because it comprises portions taken off by rotating, bore holes and functional surfaces e.g., for fixing the universal milling tool 10 to an adapter or a tool spindle.

In the FIGS. 2A, 4A and 5 the thickness D1 of the base body 30 is shown, so as to set the corresponding elements of the universal milling tool 10 in relation to one another. The outer diameter of the base body 30 is referenced with RA in the FIGS. 2A, 4A and 5.

Embodiments shall now be described on the basis of the FIG. 2A and the following. These Figures show some machining phases of the method in a strongly schematic representation. Each of these Figures shows only one single tooth gap of a workpiece 20.1 and the corresponding cutters 13, 14 of the universal tool 10.

Where necessary, a distinction is deliberately made between pre-machining and finish pre-machining. These terms are clarified on the basis of the following description and the figures. In addition, a distinction is made in the following between the soft machining, respectively the soft tooth cutting, and the hard machining, respectively the hard tooth cutting. Prior to the hard tooth cutting, the workpiece, which is referenced here as bevel gear 20.1, 20.2, is subjected to a temperature or heat treatment. Accordingly, in the following, the words gear pre-cutting, soft milling, etc. are employed if machining steps on the “soft” workpiece are concerned.

In the following, pre-toothed elements are referenced by an upper “*”. For example, 15* refers to the tooth gap prior to the hardening and 15 to the tooth gap after the hardening and hard tooth cutting.

It is a concern to soft mill a plurality of different similar bevel gears using one and the same universal hobbing tool 10. The different bevel gears are referenced by the reference numeral 20 and an index. A first bevel gear is referenced by 20.1 and a second, different but similar bevel gear is referenced by 20.2. However, of course also more than only two similar bevel gears 20.1, 20.2 may be soft milled using the universal hobbing tool 10.

The universal hobbing tool 10 is equipped with a set of bar cutters comprising plural pairs of inner cutting edges 13.1 and outer cutting edges 14.1, which may be arranged at inner cutters 13 or outer cutters 14 for example, as can be recognized in the FIGS. 2A and 2C. However, the inner cutting edges 13.1 and outer cutting edges 14.1 may also be arranged on full cutters 14, as shown in the FIGS. 4A to 4D. The pairs are respectively formed identically, i.e., the universal hobbing tool 10 is equipped for example with n identical inner cutting edges 13.1 and n identical outer cutting edges 14.1 (in all embodiments n is an integer greater than two). The inner cutting edges 13.1 and outer cutting edges 14.1 are arranged pairwisely along the circumference of the universal hobbing tool 10, wherein respectively an inner cutting edge 13.1 follows an outer cutting edge 14.1.

The universal hobbing tool 10 is applied on a first milling machine, in order to pre-tooth a first bevel gear 20.1 of the plurality of different bevel gears.

The universal hobbing tool 10 may be used on a CNC milling machine having five axes, because a CNC milling machine having five axes offers the setting possibilities for performing the novel method. However, the invention may also be applied on older machines and on machines having more than five axes.

In a first machining phase, the pairs of inner cutting edges 13.1 and outer cutting edges 14.1 are employed for the simultaneous milling machining of the convex inner flanks 21.1* and the concave outer flanks 22.1* on the first bevel gear 20.1. A snap shot of this first machining phase of a first bevel gear 20.1 is shown in FIG. 2A. A detail of the first bevel gear 20.1 is visible. In the instant shown, the inner cutting edge 13.1 machines a convex inner flank 21.1* and the outer cutting edge 14.1 machines a concave outer flank 22.1*. In the example shown, the concave outer flanks 22.1 are finish pre-toothed (called finishing pre-machining) during the first machining phase, i.e., the outer cutting edges 14.1 are applied only in this first machining phase for the milling machining. However, the convex inner flanks 21.1* have only been pre-toothed during the first machining phase, i.e., they have not yet reached the desired dimension.

FIG. 2B shows a strongly schematic top view of the first machining phase according to FIG. 2A. In FIG. 2B, an inner cutter 13 and an outer cutter 14 can be recognized, while they run sequentially through the tooth gap 15* to be machined. In the representation shown, the inner cutter 13 and the outer cutter 14 both move with a circular trajectory movement directed upwards about the center point M of the cutter head (see FIG. 5). Both cutters 13 and 14 are applied during the first machining phase. The cutting edges 13.1., 14.1 that are active in the first machining phase are characterized by the black corners in FIG. 2. In addition, the chips 18.1, 18.2 generated by the milling machining are indicated. After the first machining phase, the concave outer flanks 21.1* are finish pre-toothed and the convex inner flanks 21.1* are only pre-toothed.

Now, in a subsequent second machining phase, the same inner cutting edges 13.1 are employed for a milling finishing pre-machining of the convex inner flanks 21.1* on the bevel gear 20.1, as shown in FIG. 2C. Prior to the second machining phase, at least one machine setting of the milling machine is changed. In FIG. 2C, the prescription of another machine setting is represented schematically by the arrow P1. The readjusting of the machine setting typically comprises a rotation of the workpiece and a change of the radial and the rolling angle of the universal tool 10. However, the readjusting of the machine setting may also be performed in another way.

After the end of the first machining phase, the tooth gap 15* has a gap width (=base width) which is characterized by e*_{fn,soft} as shown in FIG. 2A. The gap width e*_{fn,soft} corresponds to the tip width w_{soft} of the two outer and inner cutters 13, 14. FIG. 2D shows a strongly schematic top view of the second machining phase according to FIG. 2C. In FIG. 2D, the inner cutting edge 13.1 and the outer cutting edge 14.1 can be recognized, while they run sequentially through the tough gap 15* to be machined. In the representation shown, the inner cutter 13 and the outer cutter 14 both move with a relative movement directed upwards with respect to the bevel gear 20.1. During the second machining phase, only the inner cutting edges 13.1 are employed. The cutting edge 13.1 of the inner cutter 13 that is active during the second machining phase is characterized by a black corner. In addition, the chip 18.3 generated by the milling machining is indicated. The outer cutting edges 14.1 are not actively machining at this point.

After the second machining phase, all the flanks 21.1* and 22.1* are finish pre-toothed. The finished pre-toothed tooth gap 15* is shown in FIG. 2E. It now has a gap width e_{fn,soft} that is greater than the gap width e*_{fn,soft}.

The universal hobbing tool 10 with the same set of bar cutters is employed on the first or on a second milling machine, so as to pre-tooth a second bevel gear 20.2 of the plurality of similar bevel gears. This second bevel gear 20.2 differs only slightly from the first bevel gear 20.1.

The method for soft milling of toothings of bevel gears of a plurality of similar bevel gears may, however, also be performed using full cutters 40, as is set forth in the following on the basis of a further embodiment example.

A further method is represented in the FIGS. 4A to 4E. Here a plurality of full cutters 40 comprising inner cutting edges 13.1 and outer cutting edges 14.1 are employed. Different to the embodiment examples that have been shown and described so far, an inner cutter 13 and an outer cutter 14 are respectively combined to a full cutter 40 with an inner cutting edge 13.1 arranged accordingly and an outer cutting edge 14.1 arranged accordingly.

In FIG. 4A, a full cutter 40 comprising an inner cutting edge 13.1 and an outer cutting edge 14.1 can be recognized, while it runs through the tooth gap 15* to be machined. The inner cutting edge 13.1 and the outer cutting edge 14.1 of the full cutter 40 both move with a circular trajectory movement about the center point M of the cutter head (see FIG. 5). During the first machining phase, the inner cutting edge 13.1 and the outer cutting edge 14.1 are employed, as can be recognized in FIG. 4A. After the first machining phase, the concave outer flanks 22.1* are finish pre-toothed and the convex inner flanks 21.1* are only pre-toothed.

Now, in a subsequent second machining phase, the same inner cutting edges 13.1 of the full tool 40 are employed for the milling finishing pre-machining of the convex inner flanks 21.1* on the bevel gear 20.1, as shown in FIG. 4B. During the second machining phase, only the inner cutting edges 13.1 are employed. Prior to the second machining phase, at least one machine setting of the milling machine is changed. In FIG. 4B, the prescription of a different machine setting is represented schematically by the arrow P3. The readjusting of the machine setting typically comprises a rotation of the workpiece and a change of the radial and the rolling angle of the universal tool 10. However, the readjusting of the machine setting may also be performed in a different way.

After the second machining phase, all the flanks 21.1* and 22.1* are finish pre-toothed. The finished pre-toothed tooth gap 15* is shown in FIG. 4C. It now has a gap width e_{fn,soft}.

Now, the heat treatment and subsequently the finish toothing method typically follow in further machining steps. In some embodiments, for the finish toothing, a hard machining method such as, e.g., a grinding method, is employed. The finish toothing of the bevel gear 20.3 using a full-cutting tool 16 (e.g., a grinding disk) is shown in FIG. 4D. The dotted flanks lines 21.1* and 22.1* in FIG. 4D indicate that the full-cutting tool 16 has a greater width w_{hard} in the normal direction than the gap width e_{fn,soft}.

Finally, the tooth gap 15 of the bevel gear 20.3 has the shape and dimension shown by way of example in FIG. 4E. The inner flank is now referenced with 21.1 and the outer flank with 22.1. The FIGS. 4D and 4E correspond substantially to the FIGS. 2F and 2G.

FIG. 5 shows a perspective view of an exemplary universal hobbing tool 10 that is equipped with a set of bar cutters comprising a plurality of pairs of inner cutters 13 and outer cutters 14. Typically, the universal hobbing tool 10 has a disk-shaped base body 30, on the front surface 31 of which cutter shafts 32 for inserting and fixing the inner cutters 10 and outer cutters 14 are conceived. In the example shown, the base body 30 has forty cutter shafts 32 in total. The forty cutter shafts 32 are equipped with twenty inner cutters 13 and twenty outer cutters 14.

In at least some embodiments, the inner cutters 13 and outer cutters 14 or the full cutters 40 are implemented in the form of cutter bars and have a cutter shaft length that is chosen such that the cutter shafts project on the rear front face of the base body 30. In FIG. 5, the cutter shaft of an outer cutter 14 is referenced with the reference numeral 19.

Bore holes 34 extend inwardly, e.g., radially, from the outer mantel surface 33 (which in the embodiment shown is cylindrical) and end in the cutters shafts 32, are conceived on the base body 30. Screws, which are not visible here, sit in these bore holes. Two fixing screws 35 are shown beside the universal hobbing tool 10 by way of indication.

The fixing screws 35 enable to fix the inner cutters 13 and outer cutters 14 or the full cutters 40 in the cutter shafts 32.

In the embodiment shown, the cutters shafts 32 have a rectangular shape in the top view and are arranged radially, as is indicated in FIG. 5 on the basis of two dotted lines L1, L2.

The outer cutting edges 14.1 sit on an outer circle, the center point of which coincides with the center point M of the universal hobbing tool 10. The outer circle has a circle radius ra. The inner cutting edges 13.1 sit on an inner circle, the center point of which coincides with the center point M of the universal hobbing tool 10. The inner circle has a circle radius ri. The circle radius ra is greater than the circle radius ri.

Here, RW designates the rotation axis of the tool 10. At the center point M, the rotation axis traverses the plane that is spanned by the universal hobbing tool 10.

In a third machining phase, the pairs of inner cutting edges 13.1 and outer cutting edges 14.1 may be employed for a simultaneous milling machining of the convex inner flanks 21.1* and the concave outer flanks 22.2* on this further bevel gear 20.2. A snapshot of this third machining phase is shown in FIG. 3A. The dimensions in FIG. 3A correspond to the dimensions in FIG. 2A. That is, the gap width (=base width) e*_{fn,soft} is the same for the two bevel gears 20.1 and 20.2 after the first machining phase on the bevel gear 20.1 respectively after the third machining phase on the bevel gear 20.2. A detail of the second bevel gear 20.2 can be recognized in FIG. 3A. In the instant shown, the inner cutting edges 13.1 machine the convex inner flanks 21.2* and the outer cutting edges 14.1 machine the concave outer flanks 22.2* of the second bevel gear 20.2. In the example shown, the concave outer flanks 22.2* are finish pre-toothed, i.e., the outer cutting edges 14.1 are employed only in this third machining phase for the milling machining of the second bevel gear 20.2. The convex inner flanks 21.2* have, however, only been pre-toothed during the third machining phase, i.e., they have not yet reached the desired dimension. Thus, in a subsequent fourth machining phase, the inner cutting edges 13.1 are employed for the milling finishing machining of the convex inner flanks 21.2* on this bevel gear 20.2, as shown in FIG. 3B. The dimensions in FIG. 3B correspond approximately to the dimensions in FIG. 2C. Only the gap width (=base width) e_{fn,soft} is slightly different here as compared to FIG. 2C. The gap width (=base width) e_{fn,soft} in FIG. 3B is smaller than that in FIG. 2C.

Prior to the fourth machining phase, at least one machine setting of the milling machine is changed. In some embodiments, the workpiece rotation axis of the milling machine is slightly inclined, so as to be able to employ the inner cutters 13 for the milling finishing pre-machining of the convex inner flanks 21.2* during the fourth machining phase. In FIG. 3B, the prescription of another machine setting is schematically represented by the arrow P2.

The second bevel gear 20.2 differs from the first bevel gear 20.1 in that it has another gap width e_{fn,soft} of the tooth gaps 15* at the tooth base bottom 17* in the normal direction. In the example shown, the gap width e_{fn,soft} of the second bevel gear 20.2 is smaller than the gap width e_{fn,soft} of the first bevel gear 20.1. After the finishing gear pre-cutting, a third bevel gear (not shown) may, for example, have a gap width e_{fn,soft} that is greater than the gap width e_{fn,soft} in the FIGS. 2C and 3B. It is to be observed that not only the gap width e_{fn,soft} is different in the different bevel gears.

In some embodiments, the universal hobbing tool 10 is equipped with the inner cutters 13 and outer cutters 14 and the set of bar cutters is formed such that a positive tip width results, wherein this positive tip width w_{soft} is smaller than the smallest gap width e_{fn,soft} of the tooth gaps 15.1* of the first bevel gear 20.1 and the tooth gaps 15.2* of the second bevel gear 20.2.

Now, the heat treatment and subsequently the finishing gear pre-cutting method typically follow in further machining steps. In some embodiments, a hard machining method, for example, a grinding method, is employed for the finish toothing. The finish toothing of the first bevel gear 20.1 with a full cutting tool 16 (e.g., a grinding disk) is shown in FIG. 2F. The dotted flank lines 21.1* and 22.1* in FIG. 2F indicate that the full-cutting tool 16 has a greater width w_{hard} in the normal direction than the gap width e_{fn,soft}.

The finishing toothing of the second bevel gear 20.2 occurs with another full-cutting tool (not shown), because the second bevel gear 20.2 has a different final gap width e_{fn,hard} than the first bevel gear 20.1. The final gap width e_{fn,hard} is correlated directly with the width w_{hard}. The tools that are employed for the hard machining may be identical to the tools that have been employed in conventional methods up to now.

In the finishing toothing, tools 16 are employed, which are tuned exactly to the final gap width e_{fn,hard}. The tool 16 has a tip width w_{hard} that is tuned to the final gap width e_{fn,hard} to be achieved.

Finally, the tooth gap 15 of the first bevel gear 20.1 has the shape and dimension shown by way of example in FIG. 2G. The inner flank is now referenced with 21.1 and the outer flank with 22.1.

During the first machining phase on the first bevel gear 20.1 and the third machining phase on the second bevel gear 20.2, also the inner cutting edges 13.1 may be employed for the milling finishing pre-machining of the convex inner flanks 21.1* and the outer cutting edges 14.1 for the milling pre-machining of the concave outer flanks 22.1*, respectively, i.e., the principle shown in the FIGS. 2A, 2C and 3A, 3B may also be reversed. In this case, during the second machining phase on the first bevel gear 20.1 and the fourth machining phase on the second bevel gear 20.2, only the outer cutters 14 are employed for the milling finishing pre-machining of the concave outer flanks 22.1*.

Similar bevel gears 20.1, 20.2, which may be manufactured using the methods of the invention, have a similar geometry, respectively similar dimensions. Bevel gears are ay be considered to be similar here, if their average normal module deviates only slightly, if their pressure angles deviate only slightly and if their transmission ratios are comparable, so that similar curvature conditions result at the teeth. The average normal module deviates, for example, only by ±10% at maximum for similar bevel gears 20.1, 20.2. The pressure angle deviates, for example, by ±1° at maximum for similar bevel gears 20.1, 20.2. The transmission ratio deviates, for example, by ±10% at maximum for similar bevel gears 20.1, 20.2.

As an example, a universal cutter head 10 equipped with outer cutting edges 14.1 and inner cutting edges 13.1 may manufacture, e.g., first bevel gears which have a number of teeth=24 and a transmission ratio i=2. Using the same universal cutter head 10, second bevel gears can be manufactured, which have a number of teeth=21 and a transmission ratio i=2.1.

What is claimed is:

1. Method for soft milling of bevel gear teeth of a plurality of similar bevel gears, the method comprising:
pre-cutting teeth of a first bevel gear of the plurality of similar bevel gears using a first milling machine to which is applied a universal hobbing tool comprising equipped with a set of bar cutters comprising a plurality of pairs of inner cutting edges and outer cutting edges, wherein the step of pre-cutting teeth of the first bevel gear includes:
performing a first machining phase in which the pairs simultaneously mill machine convex inner flanks and concave outer flanks on the first bevel gear, and
subsequently performing a second machining phase in which either (1) the outer cutting edges mill finish pre-machine the concave outer flanks of the first bevel gear and the inner cutting edges are not applied to the convex inner flanks thereof; or (2) the inner cutting edges mill finish pre-machine the convex inner flanks of the first bevel gear and the outer cutting edges are not applied to the concave outer flanks thereof; and
pre-cutting teeth of a second bevel gear of the plurality of similar bevel gears using one of the first milling machine and a second milling machine to which the universal hobbing tool is applied and has said set of bar cutters, wherein the step of pre-cutting teeth of the second bevel gear includes:
performing a third machining phase in which the pairs simultaneously mill machine convex inner flanks and concave outer flanks on the second bevel gear, and
subsequently performing a fourth machining phase in which either (1) the outer cutting edges mill finish pre-machine the concave outer flanks of the second bevel gear and the inner cutting edges are not applied to the convex inner flanks thereof; or (2) the inner cutting edges mill finish pre-machine the convex inner flanks of the second bevel gear and the outer cutting edges are not applied to the concave outer flanks thereof.

2. Method according to claim 1, wherein
the first machining phase includes mill finish pre-machining the convex inner flanks with the inner cutting edges and mill finish pre-machining the concave outer flanks with the outer cutting edges, and
the second machining phase includes only mill finish pre-machining the concave outer flanks with the outer cutting edges.

3. Method according to claim 1, wherein
the first machining phase includes mill finish pre-machining the convex inner flanks with the inner cutting edges and mill finish pre-machining the concave outer flanks with the outer cutting edges, and
the second machining phase includes only mill finish pre-machining the convex inner flanks with the inner cutting edges.

4. Method according to claim 1, wherein the second bevel gear of the plurality of similar bevel gears differs from the first bevel gear of the plurality of similar bevel gear in that it has a different gap width of tooth gaps at a tooth base bottom in a normal direction.

5. Method according to claim 1, wherein the set of bar cutters and the inner cutting edges and outer cutting edges are configured to define a positive tip distance smaller than a smallest gap distance of tooth gaps of the first bevel gear and of tooth gaps of the second bevel gear.

6. Method according to claim 1, wherein, after said pre-cutting steps, the first bevel gear has a different gap width and a different dimension thereof as compared to the second bevel gear.

7. Method according to claim 1, including performing the finish pre-machining of the convex inner flanks with a different milling machine setting as compared to the finishing gear pre-cutting of the concave outer flanks.

8. Method according to claim 1, further comprising, after said pre-cutting steps, finish toothing each of the similar bevel gears.

9. Method according to claim 8, wherein the finish toothing step comprises hard machining the bevel gears.

10. Method according to claim 8, wherein the finish toothing step comprises grinding the bevel gears.

11. Method according to claim 8, further comprising temperature treating the bevel gears prior to the finish toothing step.

12. Method according to claim 5, wherein the positive tip distance is smaller than a smallest rated gap distance of all bevel gears of the plurality of similar bevel gears.

13. Method according to claim 1, wherein the universal hobbing tool either
is equipped with a plurality of pairwisely arranged inner cutters and outer cutters, wherein each of the inner cutters comprises an inner cutting edge and each of the outer cutters comprises an outer cutting edge, or
is equipped with a plurality of full cutters, wherein each full cutter comprises an inner cutting edge and an outer cutting edge.

14. A method comprising gear pre-cutting a plurality of similar bevel gears on a milling machine using a universal hobbing tool including a set of bar cutters comprising a plurality of pairwisely arranged inner cutting edges and outer cutting edges having a positive tip distance smaller than a smallest tip distance of tooth gaps in a tooth base bottom in a normal direction of all of the plurality of similar bevel gears.
